(19) United States
(12) Patent Application Publication
(10) Pub. No.: US 2026/0171872 A1
(43) Pub. Date: Jun. 18, 2026

(54) ROTOR END FLANGE FOR AN ELECTRIC MOTOR

(71) Applicant: GM Global Technology Operations LLC, Detroit, MI (US)

(72) Inventors: Mark R. Claywell, Birmingham, MI (US); Brad J. Heckman, Oxford, MI (US); Carolyn Ann Schupra, Rochester Hills, MI (US); Jeffrey Wentz Yambor, Clawson, MI (US)

(21) Appl. No.: 18/984,063

(22) Filed: Dec. 17, 2024

(51) Int. Cl. H02K 9/19; H02K 1/24; H02K 3/52

(52) U.S. Cl. CPC H02K 9/19; H02K 1/24; H02K 3/527; H02K 2203/12

(57) ABSTRACT

A rotor end flange for cooling a coil wire includes a plurality of poles, pole shoes, slots, an outer surface, an inner surface, a plurality of exit holes, and a plurality of grooves. Adjacent poles and pole shoes define the slots. The outer surface is disposed on an outer diameter which is in contact with the poles. An oil enters the inner surface through the plurality of exit holes. The plurality of exit holes are disposed radially inward of the inner surface. The inner surface has a radius of curvature (ROC). The ROC directs the oil along the inner surface towards the plurality of grooves. The plurality of grooves are disposed on the outer surface and extend through the inner surface. The oil travels along the inner surface and is released from the rotor end flange through the plurality of grooves, coating and cooling the coil wire.

The present disclosure relates to a rotor end flange for an electric motor. More particularly, the present disclosure relates to a rotor end flange for a separately excited rotor in an electric motor to direct oil spread across a coil winding, cooling the coil winding.

A separately excited synchronous motor (SESM) generally includes a stator and a rotor. Instead of permanent magnets in the rotor, the SESM includes the coil winding which generates a rotor field. The magnetic field of the rotor can therefore be adjusted by a level of electric current applied to the coil winding.

The rotor includes a laminate core having poles and pole shoes that define slots. The coil winding is disposed within the slots and are wound around the poles. With the application of an electrical current to the coil winding, the rotor begins to rotate at a high speed. While rotating, the coil winding begins to heat and becomes at risk for overheating. Overheating of the coil winding may hinder the ability of the coil winding to conduct electricity, stopping the rotation of the rotor.

One solution is to attach a rotor end flange to the laminate. The rotor end flange directs oil to the coil winding, cooling the coil winding. The high rotational speed of the rotor causes the oil to create pools in a corner of the rotor end flange. Additionally, the high rotational speeds may cause the oil to exit the rotor end flange with a high axial velocity relative to the radial velocity, thus missing the coil winding. Therefore, there is a need in the art for an improved rotor end flange design to create a better spread and even oil coverage across the coil winding.

### SUMMARY

According to several aspects, a rotor end flange for cooling a coil wire is provided. The rotor end flange defines a pole central axis. The rotor end flange includes a plurality of poles. The plurality of poles extend radially away from a rotational axis. The rotor end flange further includes pole shoes. The pole shoes are disposed at radial distal ends of the poles. The rotor end flange further includes slots. Adjacent poles and adjacent pole shoes define the slots. The rotor end flange further includes an outer surface. The outer surface is disposed on an outer diameter of the rotor end flange. The outer diameter of the rotor end flange is in contact with poles of the rotor. The rotor end flange further includes an inner surface. A portion of the inner surface is curved and has a radius of curvature (ROC). The ROC directs an oil towards a plurality of grooves. The rotor end flange further includes a plurality of exit holes radially inward of the inner surface. The oil is released from the rotor into the rotor end flange through the plurality of exit holes. The plurality of grooves are disposed on the outer surface and extend through the inner surface to allow the oil to flow from the inner surface to the outer surface. The plurality of grooves extend axially allowing the oil to spread across the coil winding.

In an additional aspect of the present disclosure, the plurality of exit holes is aligned to the pole central axis.

In an additional aspect of the present disclosure, the ROC of the inner surface increases from the pole central axis to a leading side. The ROC of the inner surface increases from the pole central axis to a trailing side at a different rate. The leading side is opposite of the trailing side and nears the slots facing a direction of rotation. The trailing side nears the slots opposing the direction of rotation.

In another aspect of the present disclosure, the plurality of exit holes is a distance from the pole central axis.

In another aspect of the present disclosure, the inner surface is curved, and the curve increases from the pole central axis to a leading side. The curve decreases from the pole central axis to a trailing side. The leading side is opposite of the trailing side and nears the slots facing the direction of rotation. The trailing side nears the slots opposing the direction of rotation.

In another aspect of the present disclosure, the inner surface is curved, and the curve increases from a leading side towards a trailing side. The leading side is opposite of the trailing side and nears the slots facing the direction of rotation. The trailing side nears the slots opposing the direction of rotation.

In another aspect of the present disclosure, the ROC of the inner surface gradually decreases from the plurality of exit holes positioned on a leading side while moving towards a trailing side. The leading side is opposite of the trailing side and nears the slots facing the direction of rotation. The trailing side nears the slots opposing the direction of rotation.

In another aspect of the present disclosure, the plurality of grooves further includes a center groove. The center groove is aligned to the pole central axis.

In another aspect of the present disclosure, the center groove defines a V-shape. A width of the center groove increases while moving radially outward towards the outer diameter of the rotor end flange.

In another aspect of the present disclosure, the plurality of grooves further includes an exit hole groove. The exit hole groove is aligned with the plurality of exit holes.

In another aspect of the present disclosure, the exit hole groove defines a V-shape. A width of the exit hole groove increases while moving radially outward towards the outer diameter of the rotor end flange.

In another aspect of the present disclosure, the plurality of grooves further includes a corner groove. The corner grooves is disposed a distance away from the pole central axis and is positioned between adjacent poles.

In another aspect of the present disclosure, the plurality of grooves has an axial depth and the axial depth of the plurality of grooves vary.

In another aspect of the present disclosure, the plurality of grooves has a length and the length of the plurality of grooves vary.

In another aspect of the present disclosure, the plurality of grooves further includes an inner edge. The inner edge matches a contour of the coil winding.

In another aspect of the present disclosure, the plurality of grooves further comprises an inner edge. The inner edge is perpendicular to the plurality of poles and approaches the coil winding.

In another aspect of the present disclosure, a portion of the inner edge is in contact with the coil winding.

According to several aspects, a cooling system for cooling a coil winding in a rotor is provided. The cooling system includes an oil. The oil is inserted into a center of the rotor. The cooling system further includes a rotor end flange. The rotor end flange defines a pole central axis. The rotor end flange includes a plurality of poles. The plurality of poles extend radially away from a rotational axis. The rotor end flange further includes pole shoes. The pole shoes are disposed at radial distal ends of the poles. The rotor end flange further includes slots. Adjacent poles and adjacent pole shoes define the slots. The rotor end flange further includes an outer surface. The outer surface is disposed on an outer diameter of the rotor end flange. The outer diameter of the rotor end flange is in contact with poles of the rotor. The rotor end flange further includes an inner surface. A portion of the inner surface is curved and has a radius of curvature (ROC). The ROC directs an oil towards a plurality of grooves. The rotor end flange further includes a plurality of exit holes radially inward of the inner surface and positioned a distance away from the pole central axis towards a trailing side. The trailing side nears the slots opposing the direction of rotation. The oil is released from the rotor into the rotor end flange through the plurality of exit holes. The plurality of grooves are disposed on the outer surface and extend through the inner surface to allow the oil to flow from the inner surface to the outer surface. The plurality of grooves extend axially allowing the oil to spread across the coil winding. The oil is released from the rotor end flange through the plurality of grooves and spreads across the coil winding.

In another aspect of the present disclosure, the cooling system further includes an external oil jet. The external oil jet releases the oil externally from the rotor and covers the coil winding with the oil.

According to several aspects, a rotor end flange for cooling a coil winding in a rotor is provided. The rotor end flange defines a pole central axis. The rotor end flange includes a plurality of poles. The plurality of poles extend radially away from a rotational axis. The rotor end flange further includes pole shoes. The pole shoes are disposed at radial distal ends of the poles. The rotor end flange further includes slots. Adjacent poles and adjacent pole shoes define the slots. The rotor end flange further includes an outer surface. The outer surface is disposed on an outer diameter of the rotor end flange. The outer diameter of the rotor end flange is in contact with poles of the rotor. The rotor end flange further includes an inner surface. A portion of the inner surface is curved and has a radius of curvature (ROC). The ROC directs an oil towards a plurality of grooves. The ROC of the inner surface increases from the pole central axis to a leading side. The ROC of the inner surface increases from the pole central axis to a trailing side at a different rate. The leading side is opposite of the trailing side and nears the slots facing a direction of rotation. The trailing side nears the slots opposing the direction of rotation. The rotor end flange further includes a plurality of exit holes radially inward of the inner surface. The oil is released from the rotor into the rotor end flange through the plurality of exit holes. The plurality of exit holes is aligned to the pole central axis. The plurality of grooves are disposed on the outer surface and extend through the inner surface to allow the oil to flow from the inner surface to the outer surface. The plurality of grooves extend axially allowing the oil to spread across the coil winding.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an isometric view of a rotor of a separately excited synchronous motor (SESM) having a rotor end flange according to an exemplary embodiment.

FIG. 2 is an isometric view of the rotor end flange according to an exemplary embodiment.

FIG. 3 is an enlarged view of the rotor end flange according to an exemplary embodiment.

FIG. 4 is a top view of the rotor end flange according to an exemplary embodiment.

FIG. 5 is a top view of the rotor end flange according to an exemplary embodiment.

FIG. 6 is a top view of the rotor end flange according to an exemplary embodiment.

FIG. 7 is an enlarged view of an alternate embodiment of the rotor end flange according to an exemplary embodiment.

FIG. 8 is a top view of an alternate embodiment of the rotor end flange according to an exemplary embodiment.

### DETAILED DESCRIPTION

The following description is merely exemplary in nature and is not intended to limit the present disclosure, application, or uses.

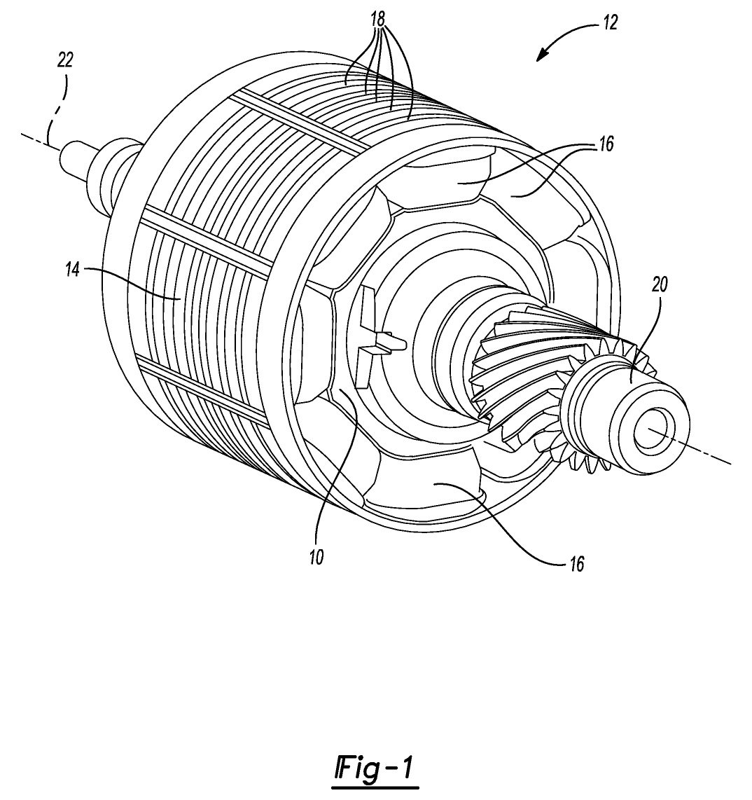

Referring to FIG. 1, a rotor end flange 10 according to the principles of the present disclosure is illustrated with an exemplary rotor 12. The rotor 12 is part of a separately excited synchronous motor (SESM) (not shown). The SESM converts electrical energy into mechanical energy when a current is applied to the rotor 12. The rotor 12 includes a laminate core 14 and a coil winding 16. The coil winding 16 is a wire wound about the laminate core 14.

The laminate core 14 supports the coil winding 16 and is comprised of a number of laminates 18. The laminates 18 are stacked together to form the laminate core 14. The laminate core 14 is connected to an output shaft 20 of the rotor 12. The output shaft 20 defines a rotational axis 22 of the rotor 12 about which the rotor 12 rotates.

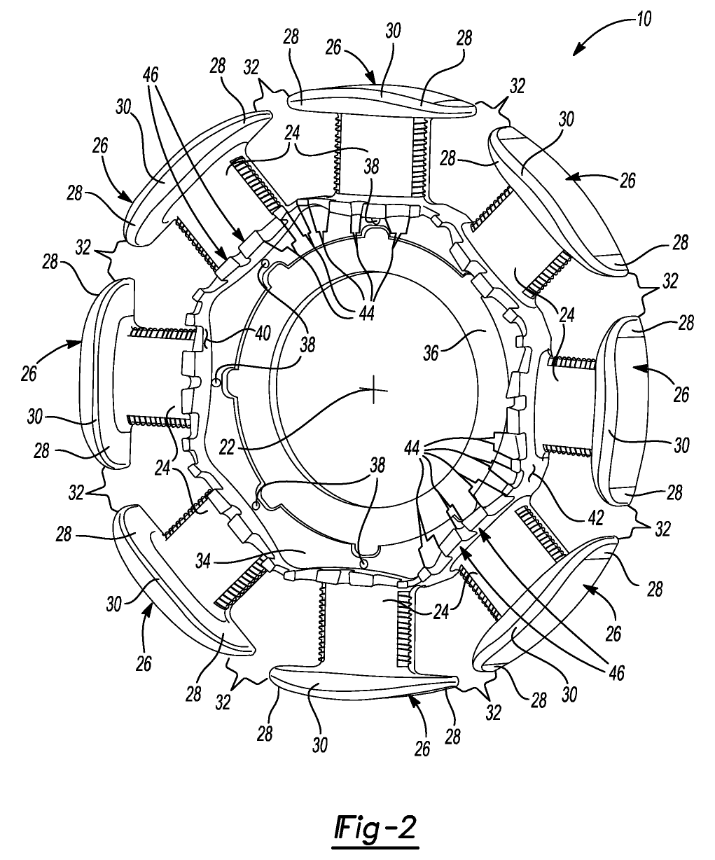

Referring to FIG. 2, the rotor end flange 10 is illustrated. The rotor end flange 10 attaches to the laminate core 14. The rotor end flange 10 includes a plurality of poles 24 that extend radially away from the rotational axis 22. Each of the plurality of poles 24 has a curved outer portion 26 and each includes pole shoes 28. The pole shoes 28 are disposed at radial distal ends 30 of the plurality of poles 24 and extend circumferentially away from the plurality of poles 24. Adjacent poles 24 and adjacent pole shoes 28 define slots 32 within the rotor end flange 10.

The rotor end flange 10 also includes a top portion 34 and a bottom portion 36. The top portion 34 is composed of a plastic which electrically insulates the coil winding 16 and maintains distance between the coil winding 16 and the bottom portion 36. The bottom portion 36 is composed of a steel.

The top portion 34 of the rotor end flange 10 includes a plurality of exit holes 38, an inner surface 40, an outer surface 42, and a plurality of grooves 44. The plurality of exit holes 38 are radially inward of the inner surface 40. An oil is released through the plurality of exit holes 38 and the oil travels along the inner surface 40. The inner surface 40 is curved and has a radius of curvature (ROC), where the ROC and the curve of the inner surface guides the oil towards the plurality of grooves 44, as will be described in greater detail below. The plurality of grooves 44 are disposed on an edge 46 of the outer surface 42 and extend through to the inner surface 40. The outer surface 42 is disposed on the outer diameter of the rotor end flange 10 and in contact with the plurality of poles 24. The oil is released from the rotor end flange 10 through the plurality of grooves 44, coating the coil winding 16 (shown in FIG. 1).

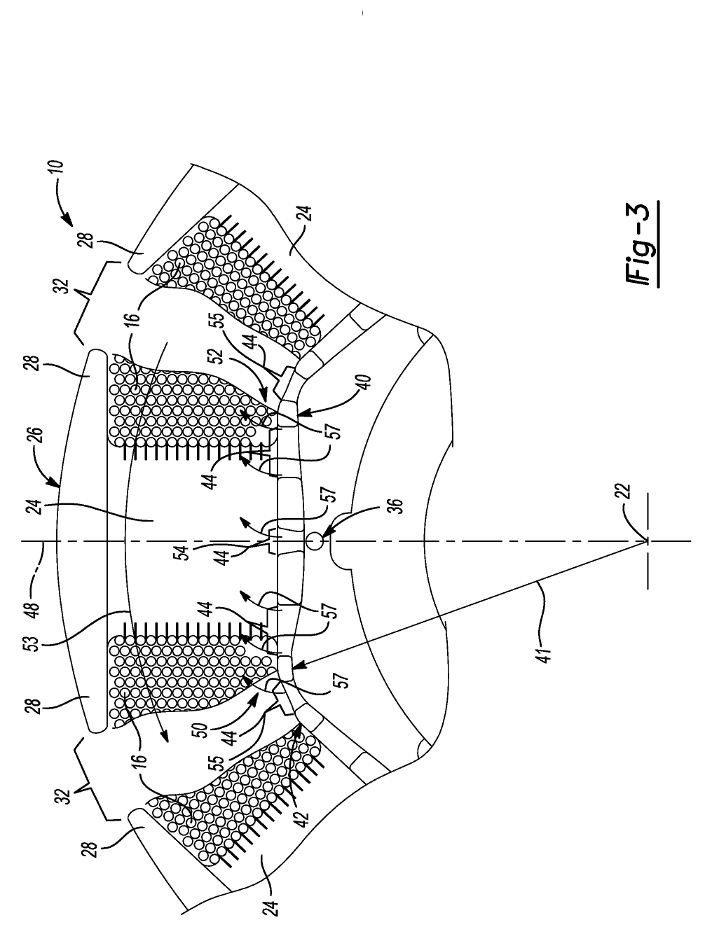

Referring to FIG. 3, an enlarged view of the rotor end flange 10 is illustrated. Portions of the coil winding 16 are wrapped around the plurality of poles 24 and are disposed within the slots 32 of the rotor end flange 10. When a current is applied to the coil winding 16, the rotor 12 (shown in FIG. 1) begins to rotate at a high speed, creating heat. To cool the coil winding 16 and prevent the coil winding 16 from overheating, an oil is supplied to the rotor (shown in FIG. 1). The oil leaves the rotor 12 while under high rotational speeds through the exit holes 38 of the rotor end flange 10. The plurality of exit holes 38 are disposed radially inward of the inner surface 40 and positioned along a pole central axis 48.

Once the oil is released from the exit holes 38, the oil travels along the inner surface 40. The inner surface 40 is curved and has an ROC 41. The oil travels towards the highest ROC 41. The ROC 41 is defined as a radius from the rotational axis 22 to the inner surface 40. The direction and rate of oil flow changes dependent on the ROC 41. The ROC 41 changes while traveling across the inner surface 40 of the rotor end flange 10. The ROC 41 of the inner surface 40 is the lowest at the pole central axis 48. The ROC 41increases when moving away from the pole central axis 48 towards a leading side 50 and when moving towards a trailing side 52. The ROC 41 increases at a different rate while moving towards the leading side 50 than when the ROC 41 is increasing towards the trailing side 52. The increase in ROC 41 away from the pole central axis 48 causes the inner surface 40 to direct the oil to the leading side 50 of the pole 24 and to the trailing side 52 of the pole 24. The leading side 50 is opposite of the trailing side 52 and nears the slots 32 facing a direction of rotation 53. The trailing side 52 nears the slots 32 opposing the direction of rotation 53.

The curve of the inner surface 40 further directs the travel of the oil along the inner surface 40. The curve may gradually increase from the plurality of exit holes 38 positioned on the pole central axis 48 towards the leading side 50. This directs the oil towards the leading side 50. Alternatively, the curve of the inner surface 40 may increase from the plurality of exit holes 38 towards the trailing side 52. This directs the oil towards the trailing side 52.

While the oil travels along the inner surface 40, the oil exits the rotor end flange 10 to cover the coil winding 16 through the plurality of grooves 44. The plurality of grooves 44 are disposed on the outer surface 42 and extend through the inner surface 40 of the rotor end flange 10. The location of the plurality of grooves 44 along the outer surface 42 and the inner surface 40, determines how far the oil must travel before being released from the rotor end flange 10 to coat the coil winding 16. The oil exits the plurality of grooves 44 at a speed towards a direction of travel 57. The direction of travel 57 of the oil opposes the direction of rotation 53. For example, if the direction of rotation 53 is counterclockwise, the direction of travel 57 is clockwise. The plurality of grooves 44 may vary in shape and sizes. One of the plurality of grooves 44 is a center groove 54. The center groove 54 is disposed along the pole central axis 48. The center groove 54 defines a V-shape, where the width of the center groove 54 increases while moving radially outward towards the outer diameter of the rotor end flange 10. The plurality of grooves 44 further includes corner grooves 55. The corner grooves 55 is disposed on the outer surface 42 and is positioned between adjacent poles 24. The plurality of grooves 44 may also have a groove or sets of grooves located a distance away from the pole central axis 48.

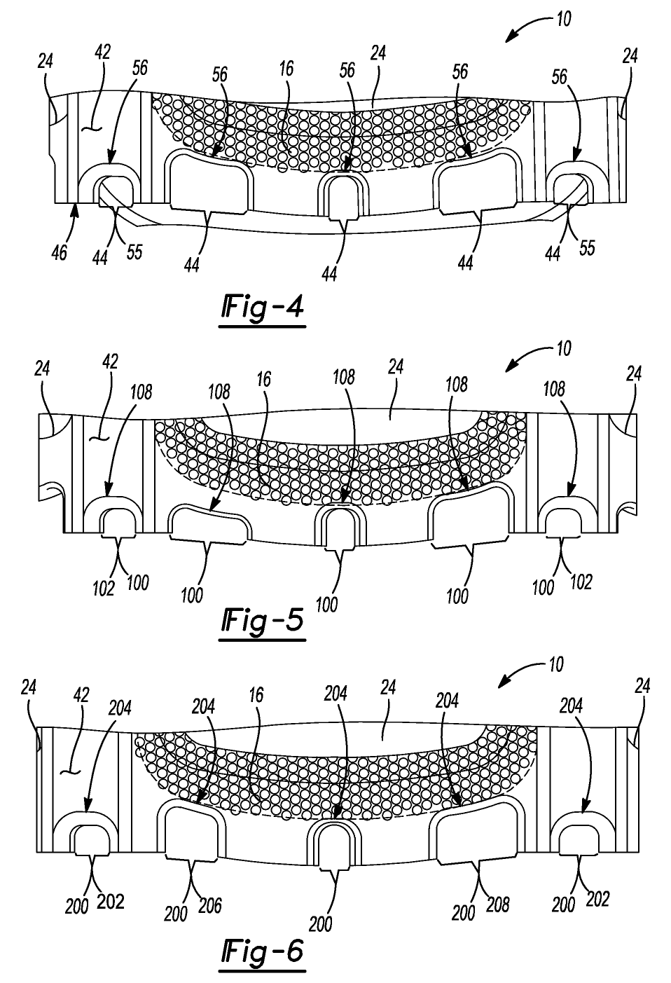

Referring to FIG. 4, an enlarged top view of the rotor end flange 10 is illustrated. The plurality of grooves 44 are disposed on the outer surface 42 and extend through to the inner surface 40. Some of the plurality of grooves 44 are in contact with the coil winding 16. The corner grooves 55 are not in contact with the coil winding 16. An inner edge 56 of the plurality of grooves 44 in contact with the coil winding 16 is curved to match a contour of the coil winding 16. The curved contour of the inner edge 56 allows the entire inner edge 56 to be in contact with the coil winding 16. The contact of the inner edge 56 with the coil winding 16 enables the oil to spread and cover the coil winding 16 evenly. Additionally, the curved inner edge 56 further allows the oil to be released from the rotor end flange 10 without missing the coil winding 16.

Referring to FIG. 5, an enlarged top view of the rotor end flange 10 is illustrated with an alternate embodiment of the plurality of grooves 44, indicated by reference number 100. The plurality of grooves 100 are disposed on the outer surface 42. The plurality of grooves 100 includes corner grooves 102 which are positioned between adjacent poles 24. An inner edge 108 of the plurality of grooves 100, not including the corner grooves 102, is curved to match the contour of the coil winding 16. The plurality of grooves 100 have varying axial depths. For example, the plurality of grooves 100 may include a leading groove 104 and a trailing groove 106. The trailing groove 106 has an inner edge 108 that extends to and is in contact with the coil winding 16. The leading groove 104 has an inner edge 108 not in contact with the coil winding 16. In other words, the trailing groove 106 has a greater axial depth than the leading groove 104. The varying axial depths of the plurality of grooves 100 changes the location of oil release. The axial depths of the plurality of grooves 100 may be altered dependent on the direction of rotation 53 of the rotor 12. For example, if the direction of rotation 53 is counterclockwise, the axial depth of the plurality of grooves 100 nearing the leading side 50 from the pole central axis 48 may be greater than the axial depth of the plurality of grooves 100 nearing the trailing side 52 from the pole central axis 48. This would direct the oil towards the leading side 50. The axial depth for each of the plurality of grooves 100 may also be altered to optimize the oil coverage for a given speed of rotation.

Referring to FIG. 6, an enlarged top view of the rotor end flange 10 is illustrated with another alternate embodiment of the plurality of grooves 44, indicated by reference number 200. The plurality of grooves 200 is disposed on the outer surface 42 of the rotor end flange 10. The plurality of grooves 200 includes the corner grooves 202 which is positioned between adjacent poles 24. The inner edge 204 of the plurality of grooves 200, not including the corner grooves 202, is curved to match the contour of the coil winding 16. The inner edge 204 of the plurality of grooves 200 is in contact with the coil winding 16. The plurality of grooves 200 have a length that extends radially along the outer surface 42. The length of the plurality of grooves 200 may vary. For example, the plurality of grooves 200 may include a leading groove 206 and a trailing groove 208. The trailing groove 208 has a length that extends along the outer surface 42 and the leading groove 206 has a different length that extends along the outer surface 42. The length of the trailing groove 208 is greater than the different length of the leading groove 206. The varying lengths of the plurality of grooves 200 alter the amount of oil released from one of the plurality of grooves 200. For example, one of the plurality of grooves 200 with a longer length will allow for more oil to be released from that one of the plurality of grooves 200, directing more oil flow in the direction of that one of the plurality of grooves 200. The varying lengths may also determine how far the oil will travel before being released onto the coil winding 16. A longer length may be disposed closer to the plurality of exit holes 38, causing the oil to have a shorter distance to travel before being released onto the coil winding 16.

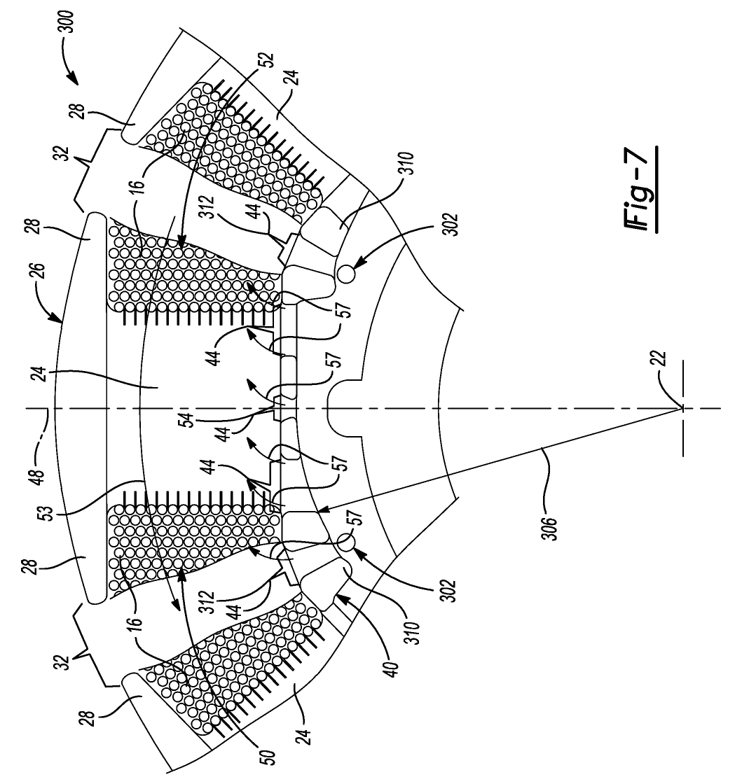

Referring to FIG. 7, an enlarged view of an alternate embodiment of the rotor end flange 300 is illustrated. The rotor end flange 300 is similar to the rotor end flange 10 and therefore like components are indicated by like reference numbers. However, the rotor end flange 300 includes a plurality of exit holes 302 located in a different position than exit holes 38 (FIG. 3). In addition, the rotor end flange 300 includes an inner surface 304 having a different profile than the inner surface 40 (FIG. 3). The rotor end flange 300 directs oil to cool the coil winding 16. The rotor end flange 300 includes a plurality of exit holes 302, an inner surface 304, an outer surface 42, and a plurality of grooves 44.

The oil is released from the rotor 12 (shown in FIG. 1) and enters the rotor end flange 300 through the plurality of exit holes 302. The plurality of exit holes 302 are radially inward of the inner surface 304. The plurality of exit holes 302 are disposed a distance away from the pole central axis 48. One of the plurality of exit holes 302 may be disposed an equal distance as a different one of the plurality of exit holes 302 but in opposite directions from the pole central axis 48. Additionally, one of the plurality of exit holes 302 may be disposed a first distance away from the pole central axis 48 and a different one of the plurality of exit holes 302 may be disposed a second distance away from the pole central axis 48. The first distance and the second distance are opposite in directions and are not equal.

By disposing the plurality of exit holes 302 a distance away from the pole central axis 48, the oil is directed to coat the coil winding 16 where the plurality of exit holes 302 are located. For example, if one of the plurality of exit holes 302 is disposed a distance from the pole central axis 48 towards the leading side 50, the oil will be directed to cool the leading side 50 of the coil winding 16. Additionally, if one of the plurality of exit holes 302 is disposed a distance from the pole central axis 48 towards the trailing side 52, the oil is directed to cool the trailing side 52 of the coil winding 16. The leading side 50 is opposite of the trailing side 52 and nears the slots 32 facing the direction of rotation 53. The trailing side 52 nears the slots 32 opposing the direction of rotation 53.

Prior to the oil coating the coil winding 16, the oil travels along the inner surface 304. The inner surface 304 has a radius of curvature (ROC) 306, where the ROC 306 guides the oil towards the plurality of grooves 44. The ROC 306 is defined as a radius, from the rotational axis 22 to the inner surface 304. The ROC 306 of the inner surface 304 increases when moving away from the pole central axis 48 towards a leading side 50 and when moving towards a trailing side 52. The oil travels towards the leading side 50 and the trailing side 52, where the ROC 306 is at its highest. Alternatively, the leading side 50 and/or trailing side 52 do not have the highest the ROC 306 when the inner surface 40 further includes a lip 310.

The lip 310 is a portion of the inner surface 304 that extends radially inwards. The lip 310 nears the plurality of exit holes 302 and is positioned towards the leading side 50 of the plurality of exit holes 302. This further directs the oil towards the plurality of exit holes 302 and the plurality of grooves 44. The lip 310 guides the oil to be released from the rotor end flange 300 and to coat the coil winding 16 that is wrapped around one of the plurality of poles 24 that nears the plurality of exit holes 302.

The inner surface 304 may also be curved. The curve of the inner surface 304 further directs the oil to the plurality of grooves 44. The curve may gradually decrease from one of the plurality of exit holes 302 positioned on the leading side 50 while moving towards the trailing side 52. This directs the oil towards the leading side 50. The oil can also be directed towards the leading side 50 by having a high curve in the leading side 50 that gradually decreases towards the pole central axis 48 and reaches a point of no curvature. In other words the curve of the inner surface 304 is flat at the pole central axis 48 and continues to be flat while moving towards the trailing side 52.

The plurality of grooves 44 are disposed on an edge 46 of the outer surface 42 and extend through to the inner surface 304. While the oil travels along the inner surface 304, the oil exits the rotor end flange 300 through the plurality of grooves 44 and covers the coil winding 16. The oil is directed towards the highest ROC 306. One of the plurality of grooves 44 is aligned with the highest ROC 306 of the inner surface 304. The oil exits the plurality of grooves 44 at a speed towards the direction of travel 57. The direction of travel 57 of the oil opposes the direction of rotation 53. For example, if the direction of rotation 53 is counterclockwise, the direction of travel 57 is clockwise. The plurality of grooves 44 may vary in shape and sizes. The plurality of grooves 44 includes a center groove 54 and an exit hole groove 312.

The center groove 54 is disposed along the pole central axis 48. The center groove 54 defines a V-shape, where the width of the center groove 54 increases while moving radially outward towards the outer diameter of the rotor end flange 300. The plurality of grooves 44 may also have a groove or sets of grooves disposed on the outer surface 42 of the rotor end flange 300 having a distance from the pole central axis 48.

The exit hole groove 312 is disposed on the outer surface 42 and extends through to the inner surface 304. The exit hole groove 312 is aligned with the plurality of exit holes 302. The exit hole groove 312 defines a V-shape, where the width of the exit hole groove 312 increases while moving radially outward towards the outer diameter of the rotor end flange 300. The exit hole groove 312 creates a direct path for the oil to be released from the plurality of exit holes 302 to the coil winding 16.

In addition to the oil being released from within the rotor 12 (shown in FIG. 1), an external oil jet (not shown) can spread oil across the coil winding 16. The external oil jet covers the leading side 50 of the coil winding 16 with oil. When an external jet is present, the exit hole 302 is a distance away from the pole central axis 48 towards the trailing side 52. The oil released from the rotor end flange 300 will be directed towards the trailing side 52 of the coil winding 16. This creates a spread of oil across the coil winding 16, cooling the coil winding 16 and lowering the coil winding’s 16 peak temperature.

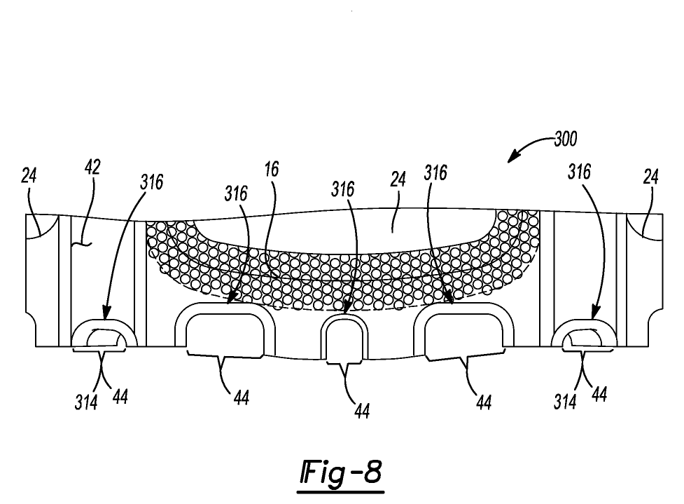

Referring to FIG. 8, an enlarged top view of the rotor end flange 300 is illustrated. The plurality of grooves 44 are disposed on the outer surface 42. The plurality of grooves 44 extend axially towards the coil winding 16 to create a depth. The plurality of grooves includes a corner groove 314. The axial depth is equal for each one of the plurality of grooves 44, not including the corner grooves 314. The plurality of grooves 44 includes an inner edge 316 that approaches the coil winding 16. The inner edge 316 is perpendicular to the plurality of poles 24. A portion of the inner edge 316 of the plurality of grooves 44, not including the corner grooves 314, is in contact with the coil winding 16. The plurality of grooves 44 also includes a length that extends radially along the outer surface 42. The length of each groove of the plurality of grooves 44 may vary.

A design for the rotor end flange 10 and the rotor end flange 300 of the present disclosure offers several advantages. These include increasing the spread of oil over the coil winding 16 and an increase in the heat transfer coefficient (HTC). The increased HTC aids in reducing peak temperatures of the coil winding 16. Additionally, the placement of the plurality of exit holes 38 and 302, the ROC 41 and 306, and the placement of the plurality of grooves 44, 100, and 200 controls the spread of the oil to specific locations of the coil winding 16, creating a more uniform spread of oil across the coil winding 16.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A rotor end flange for cooling a coil winding in a rotor, the rotor end flange defining a pole central axis and including:
a plurality of poles, wherein the plurality of poles extend radially away from a rotational axis;
pole shoes, wherein the pole shoes are disposed at radial distal ends of the poles;
slots, wherein adjacent poles and adjacent pole shoes define the slots;
an outer surface,
wherein the outer surface is disposed on an outer diameter of the rotor end flange, and
wherein the outer diameter of the rotor end flange is in contact with poles of the rotor;
an inner surface, wherein a portion of the inner surface is curved and has a radius of curvature (ROC), wherein the ROC directs an oil towards a plurality of grooves; and
a plurality of exit holes radially inward of the inner surface, wherein the oil is released from the rotor into the rotor end flange through the plurality of exit holes,
wherein the plurality of grooves are disposed on the outer surface and extend through the inner surface to allow the oil to flow from the inner surface to the outer surface, and
wherein the plurality of grooves extend axially allowing the oil to spread across the coil winding.

2. The rotor end flange of claim 1, wherein the plurality of exit holes is aligned to the pole central axis.

3. The rotor end flange of claim 2, wherein the ROC of the inner surface increases from the pole central axis to a leading side, wherein the ROC of the inner surface increases from the pole central axis to a trailing side at a different rate, wherein the leading side is opposite of the trailing side and nears the slots facing a direction of rotation, and wherein the trailing side nears the slots opposing the direction of rotation.

4. The rotor end flange of claim 1, wherein the plurality of exit holes is a distance from the pole central axis.

5. The rotor end flange of claim 4, wherein the inner surface is curved and the curve increases from the pole central axis to a leading side, wherein the curve decreases from the pole central axis to a trailing side, wherein the leading side is opposite of the trailing side and nears the slots facing the direction of rotation, and wherein the trailing side nears the slots opposing the direction of rotation.

6. The rotor end flange of claim 4, wherein the inner surface is curved and the curve increases from a leading side towards a trailing side, wherein the leading side is opposite of the trailing side and nears the slots facing the direction of rotation, and wherein the trailing side nears the slots opposing the direction of rotation.

7. The rotor end flange of claim 4, wherein the ROC of the inner surface gradually decreases from the plurality of exit holes positioned on a leading side while moving towards a trailing side, wherein the leading side is opposite of the trailing side and nears the slots facing the direction of rotation, and wherein the trailing side nears the slots opposing the direction of rotation.

8. The rotor end flange of claim 1, wherein the plurality of grooves further comprises a center groove, wherein the center groove is aligned to the pole central axis.

9. The rotor end flange of claim 8, wherein the center groove defines a V-shape, wherein a width of the center groove increases while moving radially outward towards the outer diameter of the rotor end flange.

10. The rotor end flange of claim 1, wherein the plurality of grooves further comprises an exit hole groove, wherein the exit hole groove is aligned with the plurality of exit holes.

11. The rotor end flange of claim 10, wherein the exit hole groove defines a V-shape, wherein a width of the exit hole groove increases while moving radially outward towards the outer diameter of the rotor end flange.

12. The rotor end flange of claim 1, wherein the plurality of grooves further comprises a corner groove wherein the corner grooves is disposed a distance away from the pole central axis and is positioned between adjacent poles.

13. The rotor end flange of claim 1, wherein the plurality of grooves has an axial depth and the axial depth of the plurality of grooves vary.

14. The rotor end flange of claim 1, wherein the plurality of grooves has a length and the length of the plurality of grooves vary.

15. The rotor end flange of claim 1, wherein the plurality of grooves further comprises an inner edge and wherein the inner edge matches a contour of the coil winding.

16. The rotor end flange of claim 1, wherein the plurality of grooves further comprises an inner edge and wherein the inner edge is perpendicular to the plurality of poles and approaches the coil winding.

17. The rotor end flange of claim 16, wherein a portion of the inner edge is in contact with the coil winding.

18. A cooling system for cooling a coil winding in a rotor, the cooling system including:
an oil, wherein the oil is inserted into a center of the rotor;
a rotor end flange, the rotor end flange defining a pole central axis and including:
a plurality of poles, wherein the plurality of poles extend radially away from a rotational axis;
pole shoes, wherein the pole shoes are disposed at radial distal ends of the poles;
slots, wherein adjacent poles and adjacent pole shoes define the slots
an outer surface,
wherein the outer surface is disposed on an outer diameter of the rotor end flange, and
wherein the outer diameter of the rotor end flange is in contact with poles of the rotor;
an inner surface, wherein a portion of the inner surface is curved and has a radius of curvature (ROC), wherein the ROC directs an oil towards a plurality of grooves;
a plurality of exit holes radially inward of the inner surface and positioned a distance away from the pole central axis towards a trailing side,
wherein the trailing side nears the slots opposing a direction of rotation, and
wherein the oil is released from the rotor into the rotor end flange through the plurality of exit holes,
wherein the plurality of grooves are disposed on the outer surface and extend through the inner surface to allow the oil to flow from the inner surface to the outer surface, and
wherein the plurality of grooves extend axially allowing the oil to spread across the coil winding,
wherein the oil is released from the rotor end flange through the plurality of grooves and spreads across the coil winding.

19. The cooling system of claim 18, further comprises an external oil jet, wherein the external oil jet releases the oil externally from the rotor and covers the coil winding with the oil.

20. A rotor end flange for cooling a coil winding in a rotor, the rotor end flange defining a pole central axis and including:
a plurality of poles, wherein the plurality of poles extend radially away from a rotational axis;
pole shoes, wherein the pole shoes are disposed at radial distal ends of the poles;
slots, wherein adjacent poles and adjacent pole shoes define the slots
an outer surface,
wherein the outer surface is disposed on an outer diameter of the rotor end flange, and
wherein the outer diameter of the rotor end flange is in contact with poles of the rotor;
an inner surface, wherein a portion of the inner surface is curved and has a radius of curvature (ROC),
wherein the ROC directs an oil towards a plurality of grooves,
wherein the ROC of the inner surface increases from the pole central axis to a leading side,
wherein the ROC of the inner surface increases from the pole central axis to a trailing side at a different rate,
wherein the leading side is opposite of the trailing side and nears the slots facing a direction of rotation, and
wherein the trailing side nears the slots opposing the direction of rotation; and
a plurality of exit holes radially inward of the inner surface,
wherein the oil is released from the rotor into the rotor end flange through the plurality of exit holes, and
wherein the plurality of exit holes is aligned to the pole central axis,
wherein the plurality of grooves are disposed on the outer surface and extend through the inner surface to allow the oil to flow from the inner surface to the outer surface, and
wherein the plurality of grooves extend axially allowing the oil to spread across the coil winding.
